(19) United States
(12) Patent Application Publication
(10) Pub. No.: US 2003/0065280 A1
(43) Pub. Date: Apr. 3, 2003

(54) Electrically-driven scalp massager

(76) Inventor: Chan Seok Park, Busan (KR)

Correspondence Address: DARBY & DARBY P.C., 805 Third Avenue, New York, NY, 10022, US

(21) Appl. No.: 10/087,068

(22) Filed: Feb. 28, 2002

(30) Foreign Application Priority Data
Sep. 28, 2001 (KR) 2001-61283

(51) Int. Cl. A61H 11/00

(52) U.S. Cl. 601/73; 601/137

(57) ABSTRACT

Disclosed is an electrically-driven scalp massager in which the procedure of massaging the scalp of a person to promote the circulation of blood while strengthening the root of hair to reduce and prevent hair loss is conveniently carried out in accordance with a simple manipulation, so that the scalp massager provides a convenience in use while being conveniently portable. The scalp massager includes a case including a handle and a head, the case being defined with a space having a desired size, a power supply mounted in the case, and charged with electric power supplied from an external power source, a motor driven by the electric power supplied from the power supply in accordance with a drive signal, and power change means for changing rotation of the motor into vibrating motions performed in a direction perpendicular to the scalp of the user, and a massage member coupled at one end thereof to the power change means of the motor, and adapted to massage the scalp while reciprocating in the direction perpendicular to the scalp.

### BACKGROUND OF THE INVENTION

1. Field of the Invention

The present invention relates to an electrically-driven scalp massager, and more particularly to an electrically-driven scalp massager for massaging the scalp of a person, thereby promoting the circulation of blood while strengthening the root of hair to reduce and prevent hair loss.

2. Description of the Related Art

Although many individuals consume a lot of time and expense for management of hair in order to improve their images while satisfying a desire to make diverse representations, they are troubled by alopecia in which hair is lost from the head due to hereditary factors or acquired factors such as stress or disease.

Diverse types of alopecia are well known. In particular, alopecia areata is known as a chronic disease. For this reason, many individuals who are troubled by alopecia areata frequently meet dermatologists or visit hair management companies in order to remedy their disease. In the past, it was known that men are mainly suffered by alopecia. However, it has recently been reported that women are suffered by alopecia due to unbalance of hormone, irregular menstruation, anemia, diet, and parturition.

In spite of the fact that hair loss is a significant problem to both men and women, there is no means for reducing or preventing hair loss.

### SUMMARY OF THE INVENTION

Therefore, the present invention has been made in view of the above mentioned problems, and an object of the invention is to provide an electrically-driven scalp massager in which the procedure of massaging the scalp of a person to promote the circulation of blood while strengthening the root of hair to reduce and prevent hair loss is conveniently carried out in accordance with a simple manipulation, so that the scalp massager provides a convenience in use while being conveniently portable.

In accordance with one aspect, the present invention provides an electrically-driven scalp massager for massaging the scalp of a user comprising: a case including a handle and a head, the case being defined with a space having a desired size; a power supply mounted in the case, and charged with electric power supplied from an external power source; drive means including a motor driven by the electric power supplied from the power supply in accordance with a drive signal, and power change means for changing rotation of the motor into vibrating motions performed in a direction perpendicular to the scalp of the user; and a massage member coupled at one end thereof to the power change means of the drive means, and adapted to massage the scalp while reciprocating in the direction perpendicular to the scalp.|

In accordance with another aspect, the present invention provides An electrically-driven scalp massager for massaging the scalp of a user comprising: a case including a handle and a head; a power supply mounted in the case, and charged with electric power supplied from an external power source; drive means driven by the electric power charged in the power supply in accordance with a drive signal; vibration generating means coupled to the drive means, and adapted to generate a vibrating force to be applied to the case; and a massage member mounted to the head of the case, and adapted to massage the scalp using the vibrating force generated from the vibrating generating means.

### BRIEF DESCRIPTION OF THE DRAWINGS

The above objects, and other features and advantages of the present invention will become more apparent after a reading of the following detailed description when taken in conjunction with the drawings, in which:

FIG. 1 is an electrically-driven scalp massager according to an embodiment of the present invention;

FIG. 2 is a sectional view schematically illustrating the electrically-driven scalp massager according to the embodiment of the present invention;

FIGS. 3 to 5 are views respectively illustrating massage members employed in accordance with different embodiments of the present invention, respectively;

FIG. 6 is a sectional view schematically illustrating an electrically-driven massager according to another embodiment of the present invention; and

FIGS. 7a to 7c are views respectively illustrating massage members employed in accordance with different embodiments of the present invention, respectively.

### DESCRIPTION OF THE PREFERRED EMBODIMENTS

Now, the present invention will be described in detail with reference to the annexed drawings.

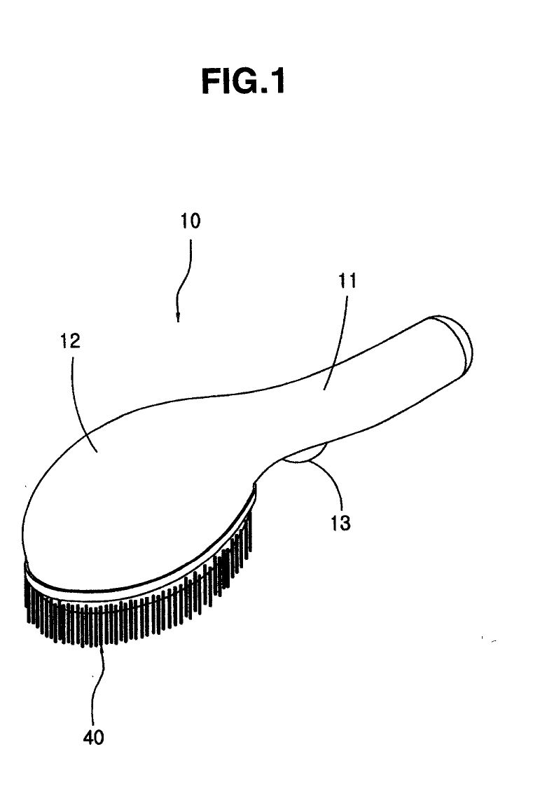

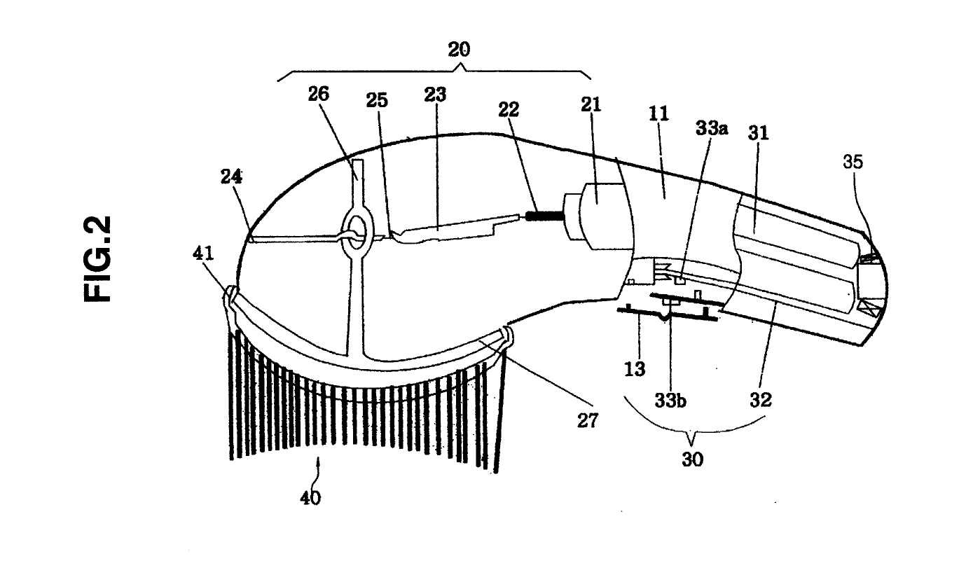

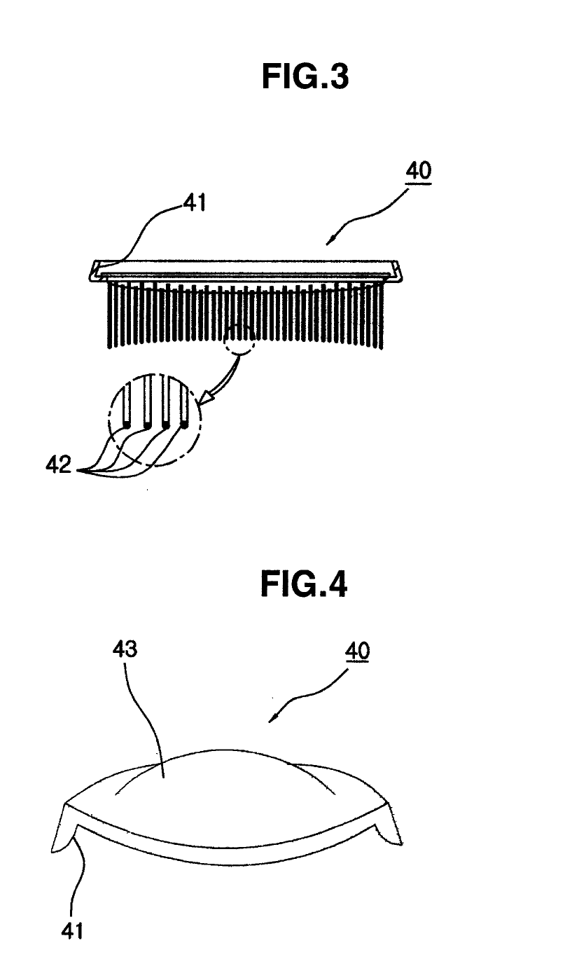

FIG. 1 is an electrically-driven scalp massager according to an embodiment of the present invention. FIG. 2 is a sectional view schematically illustrating the electrically-driven scalp massager according to the embodiment of the present invention. FIGS. 3 to 5 are views respectively illustrating massage members employed in accordance with different embodiments of the present invention, respectively.

As shown in FIGS. 1 and 2, the electrically-driven scalp massager according to the illustrated embodiment of the present invention includes a case 10 having a handle 11 configured to be grasped by the user, and a head 12 connected to the handle 11 and defined with a space having a desired size. The scalp massager also includes a motor 21 mounted in the case 10 and configured to be driven by electric power supplied in accordance with a drive signal, drive means 20 including power change means adapted to change rotation of the motor 21 into vibrating motions performed in a direction perpendicular to the scalp of the user, and a massage member 40 coupled at one end thereof to the power change means of the drive means 20, and adapted to massage the scalp while reciprocating in the direction perpendicular to the scalp.

A power supply 31 is arranged in the case 10. The power supply 31 includes a chargeable battery electrically connected to an external power source. The scalp massager further includes a control unit 30 including a switch 13 for turning on and off the drive means 20, and a controller (not shown) for controlling the operating stage of the massage member 40 between first and second stages. As shown in FIG. 2, the switch 13 may have a switch contact 33a formed on a circuit board 32, and a switch contact 33b formed at a plate spring 34. A switch cover, which is centrally provided with a protrusion, is mounted to the handle 11 at a position corresponding to the switch contacts 33a and 33b while covering those switch contacts 33a and 33b. In FIG. 2, the reference numeral 35 denotes a terminal for connecting the power supply 31 to the external power source so that the chargeable battery of the power supply 31 is charged.

The switch cover is made of a plastic resin material having an elasticity so that when the user presses the protrusion of the switch cover, the switch contacts 33a and 33b are connected to each other, thereby causing the motor 21 to be driven. When the user presses again the protrusion of the switch cover, the switch contacts 33a and 33b are disconnected from each other, thereby causing the motor 21 to be stopped.

The power change means, which is coupled to a rotating shaft 22 of the motor 21, includes a rotation transmission shaft 23 connected at one end thereof to the rotating shaft 22 to rotate in accordance with rotation of the rotating shaft 22, and a massage drive shaft 24 connected at one end thereof to the other end of the rotation transmission shaft 23 to rotate in accordance with the rotation of the rotation transmission shaft 23, and centrally formed with a curved portion. The power change means also includes a link 26 provided with a hole receiving the curved portion of the massage drive shaft 24, and adapted to change the rotation of the massage drive shaft 24 into upward and downward movements, and a pressing plate 27 formed at a lower end of the link 26, and adapted to press the massage member 40 in accordance with the upward and downward movements. In FIG. 2, the reference numeral 25 denotes a ring for connecting the rotation transmission shaft, massage drive shaft, and rotating shaft.

As shown in FIG. 3, the massage member 40 may comprise a brush member including a body plate, and a plurality of combs 42 protruded from the body plate. Alternatively, the massage member 40 may comprise a massage pad including a body plate made of a soft material such as a silicon material to allow a hair cream product to be easily coated thereon, and a massage portion 43, as shown in FIG. 4. Furthermore, as shown in FIG. 5, the massage member 40 may comprise a mineral material pad including a body plate, and a mineral material layer 44 made of jade and attached to the body plate. In either case, the massage member 40 is detachably attached to the pressing plate 27 of the head. In order to easily achieve the attachment and detachment of the massage member 40, the body plate has grooves 41.

In the case of FIG. 3, the combs 42 provided at the brush member may be formed by implanting stiff pig hair exhibiting a superior massaging effect while being harmless to the human body. Alternatively, the combs 42 may be plated with gold (Au), as shown in FIG. 3. Preferably, the combs 42 are plated with gold of 24 k at their ends. It is also preferable that the combs 42 have a minimum length at the central portion of the body plate while having a length increasing gradually toward opposite ends of the body plate, so that they form a structure having an arc-shaped concave surface.

Preferably, the mineral material pad includes a blue jade material attached to the body plate and adapted to emit ray components effective to the human body, such as far infrared rays, as shown in FIG. 5.

Now, the operation of the scalp massager having the above described configuration according to the present invention will be described.

As shown in FIGS. 1 and 2, when the electric power from the power supply 31 is applied to the motor 21 in accordance with a switching operation of the switch 13, the motor 21 is driven, thereby rotating its rotating shaft 22 and the rotation transmission shaft 23 coupled to the rotating shaft 22. As a result, the massage drive shaft 24 coupled to the rotation transmission shaft 23 is rotated.

In accordance with the rotation of the massage drive shaft 24, the link 26 connected to the curved portion of the massage drive shaft 24 is vertically reciprocated. That is, the rotation of the massage drive shaft 24 is changed into linear movements of the link 26. In accordance with the vertical movements of the link 26, the pressing plate 27 is vertically reciprocated, thereby repeatedly pressing the massage member 50 in a downward direction. Accordingly, the combs or blue jade layer attached to the massage member 40 repeatedly come into contact with the scalp of the user, thereby massaging the scalp.

Where it is desired to coat a hair cream on the scalp, the coating of the hair cream can be easily achieved using the massage pad of FIG. 4.

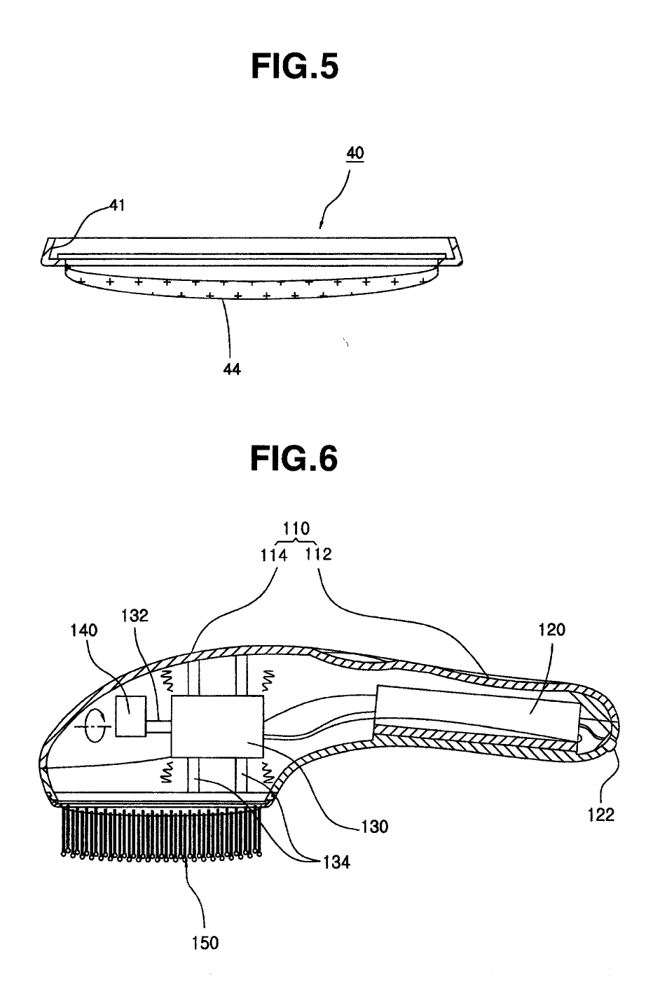

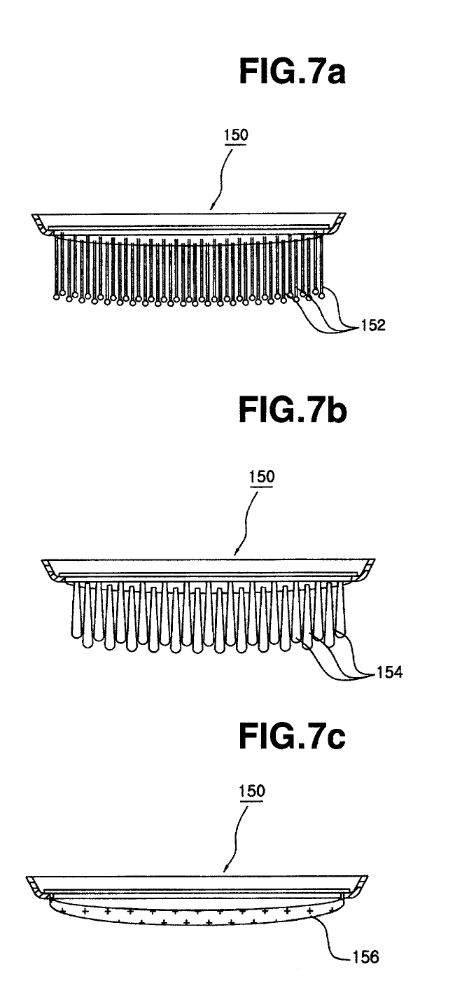

On the other hand, FIG. 6 is a sectional view schematically illustrating an electrically-driven massager according to another embodiment of the present invention. FIGS. 7a to 7c are views respectively illustrating massage members employed in accordance with different embodiments of the present invention, respectively.

As shown in FIGS. 6, and 7a to 7c, the electrically-driven scalp massager according to the illustrated embodiment of the present invention includes a case 110 having a handle 112 and a head 114 and defined with a space therein, a power supply 120 mounted in the case 110, and charged with electric power supplied from an external power source, drive means 130 configured to be driven by electric power supplied in accordance with a drive signal, vibration generating means 140 coupled to the drive means and adapted to generate a vibrating force to be applied to the case 110, and a massage member 150 adapted to massage the scalp while vibrating the vibrating force generated from the vibration generating means 140.

The drive means 130 comprises a motor, whereas the vibration generating means 140 comprises an eccentric cam coupled to a rotating shaft 132 included in the motor 130 while having a substantially hemispherical shape. Accordingly, the eccentric cam is eccentrically moved as the motor is driven, thereby generating a vibrating force. This vibrating force from the vibration generating means 140 is transmitted to the case 110 via support members 134 supporting the motor.

The power supply 120, which is electrically connected to the external power source to be charged electric power, is arranged in the case 110. The power supply 120 is provided with a terminal 122 for connecting the power supply 120 to the external power source so that a chargeable battery included in the power supply 120 is charged. The scalp massager further includes a control unit including a switch (not shown) for turning on and off the drive means 130, and a controller (not shown) for controlling the operating stage of the massage member 150 between first and second stages.

The massage member 150 may have diverse structures. For example, the massage member 150 may comprise a structure including combs 152 plated with gold, as shown in FIG. 7a. Alternatively, the massage member 150 may comprise a structure including combs 154 made of stiff pig hair exhibiting a superior massaging effect while being harmless to the human body, as shown in FIG. 7b. In addition, the massage member 150 may comprise a structure attached with a mineral material 156 such as jade, as shown in FIG. 7c. In either case, the massage member 150 is detachably attached to the head 114 of the case 110.

Now, the operation of the scalp massager having the above described configuration according to the present invention will be described.

As shown in FIG. 5, when the electric power from the power supply 120 is applied to the motor 130 in accordance with a switching operation of the switch, the motor 130 is driven, thereby rotating its rotating shaft 132 and the eccentric cam coupled to the rotating shaft 132. Accordingly, vibrations are generated in accordance with the eccentric movement of the eccentric cam. The generated vibrations are transmitted to the case 110 via the motor 130.

As a result, the massage member 150 coupled to the head 114 of the case 110 is also vibrated. Accordingly, the user massages a desired portion of his scalp while positioning the massage member at that portion. At this time, the massaging operation can be carried out in a state in which the intensity of massage is adjusted by the controller, and a desired massage member appropriately selected. As the scalp is massaged using the massager of the present invention, it is possible to reduce or prevent hair loss.

As apparent from the above description, the present invention provides an electrically-driven scalp massager capable of conveniently massaging the scalp of a person, thereby promoting the circulation of blood while strengthening the root of hair to reduce and prevent hair loss. In the scalp massager of the present invention, a massage member is automatically reciprocated to vibrate in accordance with the switching operation of a switch. Accordingly, there is a convenience in use. Diverse massage members can be detachably attached to the scalp massager, so as to allow the scalp massager to be used for diverse purposes. For example, the scalp massager of the present invention can be used to coat a hair cream on the scalp.

Although the preferred embodiments of the invention have been disclosed for illustrative purposes, those skilled in the art will appreciate that various modifications, additions and substitutions are possible, without departing from the scope and spirit of the invention as disclosed in the accompanying claims.

What is claimed is:

1. An electrically-driven scalp massager for massaging the scalp of a user comprising:
a case including a handle and a head, the case being defined with a space having a desired size;
a power supply mounted in the case, and charged with electric power supplied from an external power source;
drive means including a motor driven by the electric power supplied from the power supply in accordance with a drive signal, and power change means for changing rotation of the motor into vibrating motions performed in a direction perpendicular to the scalp of the user; and
a massage member coupled at one end thereof to the power change means of the drive means, and adapted to massage the scalp while reciprocating in the direction perpendicular to the scalp.

2. The electrically-driven scalp massager according to claim 1, wherein the massage member is selected from a group consisting of: a brush member including a body plate, and a plurality of combs protruded from the body plate; a massage pad including a body plate made of a soft material; and a mineral material pad including a body plate, and a mineral material layer made of a mineral material and attached to the body plate, and the massage member is detachably attached to the head.

3. The electrically-driven scalp massager according to claim 2, wherein the combs of the brush member is plated with gold.

4. The electrically-driven scalp massager according to any one of claims 1 to 3, wherein the power change means comprises:
a rotation transmission shaft connected at one end thereof to the motor to rotate in accordance with rotation of the motor;
a massage drive shaft connected at one end thereof to the other end of the rotation transmission shaft to rotate in accordance with the rotation of the rotation transmission shaft, the massage drive shaft being centrally provided with a curved portion;
a link provided with a hole receiving the curved portion of the massage drive shaft, and adapted to change the rotation of the massage drive shaft into upward and downward movements; and
a pressing plate formed at a lower end of the link, and adapted to press the massage member in accordance with the upward and downward movements.

5. An electrically-driven scalp massager for massaging the scalp of a user comprising:
a case including a handle and a head;
a power supply mounted in the case, and charged with electric power supplied from an external power source;
drive means driven by the electric power charged in the power supply in accordance with a drive signal;
vibration generating means coupled to the drive means, and adapted to generate a vibrating force to be applied to the case; and
a massage member mounted to the head of the case, and adapted to massage the scalp using the vibrating force generated from the vibrating generating means.

6. The electrically-driven scalp massager according to claim 5, wherein the massage member comprises: a brush member including a body plate, and a plurality of combs protruded from the body plate; or a mineral material pad including a body plate, and a mineral material layer made of a mineral material and attached to the body plate, and the massage member is detachably attached to the head.

7. The electrically-driven scalp massager according to claim 6, wherein the combs of the brush member is plated with gold.

8. The electrically-driven scalp massager according to any one of claims 5 to 7, wherein the vibration generating means comprises an eccentric cam coupled to a drive shaft included in the drive means, the eccentric cam being eccentrically moved in accordance with rotation of the drive means, thereby generating a vibrating force, and transmitting the vibrating force to the case via the drive means.
